(19) United States
(12) Patent Application Publication
(10) Pub. No.: US 2025/0202538 A1
(43) Pub. Date: Jun. 19, 2025

(54) CONTROL DEVICE, CONTROL METHOD, AND NON-TRANSITORY COMPUTER-READABLE MEDIUM

(71) Applicant: NEC Corporation, Minato-ku, Tokyo (JP)

(72) Inventors: Kohei YOSHIDA, Tokyo (JP); Ryota NIHEI, Tokyo (JP); Kenji WAKAFUJI, Tokyo (JP)

(73) Assignee: NEC Corporation, Minato-ku, Tokyo (JP)

(21) Appl. No.: 18/846,730

(22) PCT Filed: Mar. 24, 2022
(86) PCT No.: PCT/JP2022/013943

§ 371 Date: Sep. 13, 2024

(51) Int. Cl. H04B 7/04; H04B 17/309; H04W 40/20; H04W 84/06

(52) U.S. Cl. CPC H04B 7/04013; H04B 17/346; H04W 40/20; H04W 84/06

(57) ABSTRACT

An acquisition unit in a control apparatus acquires information about interference received, from a signal transmitted from a non-terrestrial network apparatus, by a signal directly transmitted from a non-terrestrial network apparatus to a terminal apparatus. A path control unit selects a usage communication path from a direct path and an indirect path, based on the information about the interference. The “direct path” is a path in which a signal is directly transmitted from the non-terrestrial network apparatus to the terminal apparatus. The “indirect path” is a path in which a signal transmitted from the non-terrestrial network apparatus indirectly reaches the terminal apparatus via an RIS of a terrestrial relay apparatus.

### TECHNICAL FIELD

The present disclosure relates to a control apparatus, a control method, and a non-transitory computer-readable medium.

### BACKGROUND ART

Various techniques related to a non-terrestrial network (NTN) are proposed (for example, Patent Literature 1).

### CITATION LIST

### Patent Literature

[Patent Literature 1] Japanese Unexamined Patent Application Publication No. 2017-168898

### SUMMARY OF INVENTION

### Technical Problem

The present inventor has found a possibility that communication quality of one non-terrestrial network may decrease due to interference, with a signal from a first non-terrestrial network apparatus (for example, an artificial satellite) included in the one non-terrestrial network to a terrestrial terminal apparatus, of a signal from a second non-terrestrial network apparatus included in another non-terrestrial network.

An object of the present disclosure is to provide a control apparatus, a control method, and a non-transitory computer-readable medium that are able to reduce a decrease in communication quality between a non-terrestrial network and a terminal apparatus.

### Solution to Problem

A control apparatus according to a first aspect is a control apparatus configured to control a usage communication path used for transmitting a signal to a terminal apparatus in a communication system including a non-terrestrial network apparatus included in a first non-terrestrial network, and a terrestrial relay apparatus including a reconfigurable intelligent surface (RIS), and the control apparatus includes:
a first acquisition means for acquiring information about interference received, from a signal transmitted from a second non-terrestrial network, by a signal directly transmitted from the non-terrestrial network apparatus to the terminal apparatus; and
a path control means for selecting the usage communication path from a direct path for direct transmission from the non-terrestrial network apparatus to the terminal apparatus, and an indirect path in which a signal transmitted from the non-terrestrial network apparatus indirectly arrives at the terminal apparatus via the terrestrial relay apparatus, based on the information about the interference.

A control method according to a second aspect is a control method executed by a control apparatus in a communication system, wherein
the communication system includes a non-terrestrial network apparatus included in a first non-terrestrial network, and a terrestrial relay apparatus including a reconfigurable intelligent surface (RIS),
the control method includes:
   acquiring information about interference received, from a signal transmitted from a second non-terrestrial network, by a signal directly transmitted from the non-terrestrial network apparatus to a terminal apparatus; and
   selecting a usage communication path used for transmitting a signal to a terminal apparatus in the communication system, from a direct path for direct transmission from the non-terrestrial network apparatus to the terminal apparatus, and an indirect path for indirect transmission from the non-terrestrial network apparatus to the terminal apparatus via the terrestrial relay apparatus, based on the information about the interference.

A non-transitory computer-readable medium according to a third aspect is a non-transitory computer-readable medium storing a program causing a control apparatus in a communication system to execute processing, wherein
the communication system includes a non-terrestrial network apparatus included in a first non-terrestrial network, and a terrestrial relay apparatus including a reconfigurable intelligent surface (RIS),
the processing includes
   acquiring information about interference received, from a signal transmitted from a second non-terrestrial network, by a signal directly transmitted from the non-terrestrial network apparatus to a terminal apparatus, and
   selecting a usage communication path used for transmitting a signal to a terminal apparatus in the communication system, from a direct path for direct transmission from the non-terrestrial network apparatus to the terminal apparatus, and an indirect path for indirect transmission from the non-terrestrial network apparatus to the terminal apparatus via the terrestrial relay apparatus, based on the information about the interference.

### Advantageous Effects of Invention

The present disclosure is able to provide a control apparatus, a control method, and a non-transitory computer-readable medium that are able to reduce a decrease in communication quality between a non-terrestrial network and a terminal apparatus.

### BRIEF DESCRIPTION OF DRAWINGS

FIG. 1 is a diagram illustrating one example of a communication system according to a first example embodiment;

FIG. 2 is a block diagram illustrating one example of a control apparatus according to the first example embodiment;

FIG. 3 is a diagram illustrating one example of a communication system according to a second example embodiment;

FIG. 4 is a diagram used for description of one example of an acquisition method of information about interference;

FIG. 5 is a block diagram illustrating one example of a control apparatus according to the second example embodiment;

FIG. 6 is a diagram illustrating one example of a communication system according to a third example embodiment.

FIG. 7 is a block diagram illustrating one example of a control apparatus according to the third example embodiment;

FIG. 8 is a diagram illustrating one example of a communication system according to a fourth example embodiment;

FIG. 9 is a block diagram illustrating one example of a control apparatus according to the fourth example embodiment;

FIG. 10 is a diagram used for description of another selection method of a usage communication path according to the fourth example embodiment;

FIG. 11 is a diagram illustrating one example of a communication system according to a fifth example embodiment;

FIG. 12 is a block diagram illustrating one example of a control apparatus according to the fifth example embodiment; and

FIG. 13 is a diagram illustrating a hardware configuration example of a control apparatus.

### EXAMPLE EMBODIMENT

Example embodiments of the present disclosure will be described below with reference to the drawings. Note that, for clarification of the description, the description and the drawings below are appropriately omitted and simplified. Further, in each of the drawings below, the same elements will be denoted by the same reference signs, and duplicate description will be omitted as necessary. Further, in the present disclosure, unless otherwise specified, “at least one of A or B (A/B)” may indicate any one of A and B, or may indicate both of A and B. Similarly, when “at least any” is used for three or more elements, it may indicate any one of the elements, or may indicate any of the plurality of elements (including all of the elements).

### First Example Embodiment

### Overview of Communication System

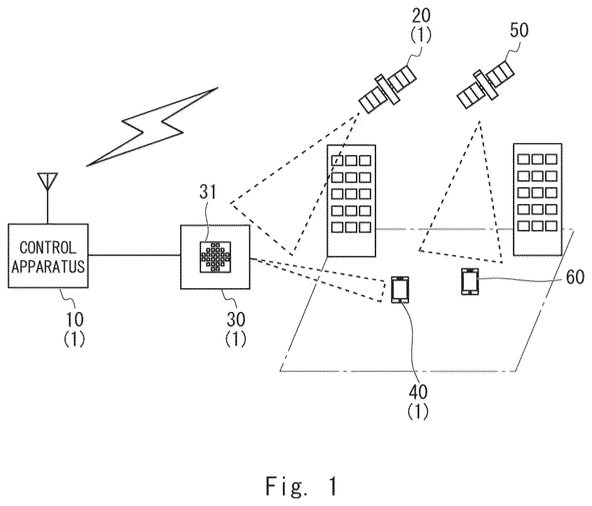

FIG. 1 is a diagram illustrating one example of a communication system according to a first example embodiment. In FIG. 1, a communication system 1 includes a control apparatus 10, a non-terrestrial network apparatus 20, a terrestrial relay apparatus 30 including a reconfigurable intelligent surface (RIS) 31, and a terminal apparatus 40. Note that, herein, in order to simplify description, one non-terrestrial network apparatus 20, one terrestrial relay apparatus 30, and one terminal apparatus 40 are illustrated, but the number of these is not limited to one. Further, the reconfigurable intelligent surface (RIS) may also be referred to as an intelligent reflecting surface (IRS).

The non-terrestrial network apparatus 20 is included in a first non-terrestrial network (NTN).

FIG. 1 illustrates a non-terrestrial network apparatus 50. The non-terrestrial network apparatus 50 is included in a second non-terrestrial network different from the first non-terrestrial network. For example, an entrepreneur providing the first non-terrestrial network is different from an entrepreneur providing the second non-terrestrial network. Thus, for example, the first non-terrestrial network and the second non-terrestrial network are in a situation difficult to operate in cooperation.

Further, FIG. 1 illustrates a terminal apparatus 60. The terminal apparatus 60 is, for example, a terminal of the entrepreneur providing the second non-terrestrial network, and can communicate with the second non-terrestrial network but cannot communicate with the first non-terrestrial network.

In such a situation, a signal directly transmitted from the non-terrestrial network apparatus 20 to the terminal apparatus 40 may receive interference from a signal transmitted from the non-terrestrial network apparatus 50 to the terminal apparatus 60. Hereinafter, the interference may be simply referred to as “interference”. The reason is that a frequency band allocated to a non-terrestrial network is limited, and thus there is a high possibility that a frequency of the first non-terrestrial network and a frequency of the second non-terrestrial network are close or overlap each other.

Herein, in FIG. 1, a path in which a signal from the non-terrestrial network apparatus 20 toward the terminal apparatus 40 passes includes a “direct path” in which a signal is directly transmitted from the non-terrestrial network apparatus 20 to the terminal apparatus 40, and an “indirect path” (hereinafter may be referred to as a “first indirect path”) in which a signal transmitted from the non-terrestrial network apparatus 20 indirectly reaches the terminal apparatus 40 via the RIS 31 of the terrestrial relay apparatus 30. In other words, a candidate (i.e., a path candidate) for a path in which a signal from the non-terrestrial network apparatus 20 toward the terminal apparatus 40 passes includes the direct path and the first indirect path.

### Configuration Example of Control Apparatus

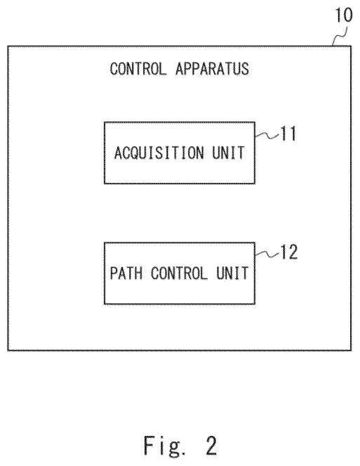

FIG. 2 is a block diagram illustrating one example of the control apparatus according to the first example embodiment. In FIG. 2, the control apparatus 10 includes an acquisition unit 11 and a path control unit 12.

The acquisition unit 11 acquires information about interference received, from a signal transmitted from the non-terrestrial network apparatus 50, by a signal directly transmitted from the non-terrestrial network apparatus 20 to the terminal apparatus 40.

The path control unit 12 selects a “usage communication path” from the direct path described above and the first indirect path described above, based on the information about the interference. The “usage communication path” is a path in which a signal from the non-terrestrial network apparatus 20 toward the terminal apparatus 40 is actually passed.

For example, when it is determined that “interference” occurs, based on the information about the interference described above, the path control unit 12 may select the first indirect path described above as the usage communication path. The first indirect path described above can transmit a signal to the terminal apparatus 40 being pinpointed by using a sharp beam of the RIS 31. Thus, avoidance of interference can be achieved. On the other hand, when it is determined that “interference” does not occur, based on the information about the interference described above, the path control unit 12 may select the direct path described above as the usage communication path.

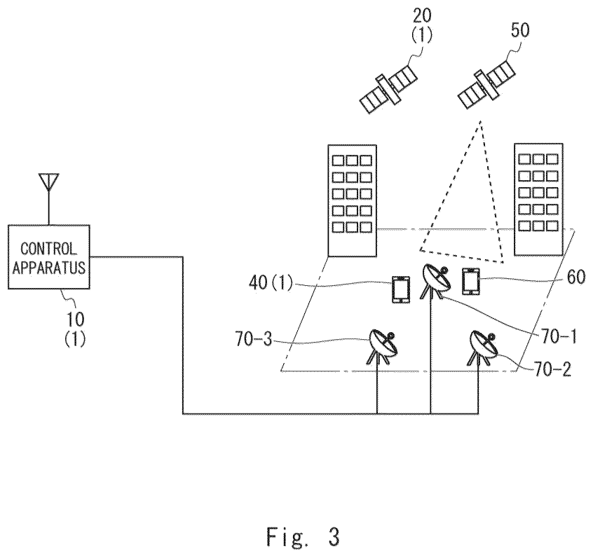

Herein, one example of a method for acquiring information about interference will be described. FIG. 3 is a diagram used for description of one example of the acquisition method of information about interference. In FIG. 3, the control apparatus 10 is connected to, for example, radio wave monitoring antennas 70-1, 70-2, and 70-3. The control apparatus 10 acquires received power of a radio wave received by the radio wave monitoring antennas 70-1, 70-2, and 70-3 in a non-transmission period of a frequency of the communication system 1. It is conceivable that received power of a radio wave in a non-transmission period of a frequency of the communication system 1 is received power of a radio wave of a communication system associated with the second non-terrestrial network. In other words, received power of a radio wave received by the radio wave monitoring antennas 70-1, 70-2, and 70-3 in a non-transmission period of a frequency of the communication system 1 can be used as information about interference.

In this case, the path control unit 12 may determine that the “interference” described above occurs when the received power indicating the information about the interference is equal to or more than a predetermined threshold value, and may determine that the “interference” does not occur when the received power indicating the information about the interference is smaller than the predetermined threshold value. Note that there is a possibility that a radio wave radiated from the non-terrestrial network apparatus 20 to the direct path may become interference with another communication system. Thus, the control apparatus 10 may cause the non-terrestrial network apparatus 20 to start communication by the direct path only after received power of a radio wave in the vicinity of a frequency of the communication system 1 is not observed. In this way, interference from the communication system 1 with another communication system can be reduced.

Note that the control apparatus 10 may acquire information about a position of the terminal apparatus 40. Then, the control apparatus 10 may include an RIS control unit (not illustrated) that controls a beam radiation direction of the RIS 31 in such a way that a radiation direction of a beam radiated from the RIS 31 is directed to a direction of the terminal apparatus 40. For example, the RIS control unit (not illustrated) forms a phase control signal that controls a phase of a signal radiated from the RIS 31 in such a way that a beam radiation direction of the RIS 31 is directed to a direction of the terminal apparatus 40. The control apparatus 10 passes the phase control signal to the terrestrial relay apparatus 30, and thus the RIS 31 adjusts a phase of a signal output from each element. Herein, when the terminal apparatus 40 and the non-terrestrial network apparatus 20 can communicate with each other, the information about a position of the terminal apparatus 40 may be acquired by the control apparatus 10 from the terminal apparatus 40 via the non-terrestrial network apparatus 20. Further, when the terminal apparatus 40 and the non-terrestrial network apparatus 20 cannot communicate with each other due to “interference”, the information about a position of the terminal apparatus 40 may be acquired by the control apparatus 10 from the terminal apparatus 40 via a terrestrial communication network.

Further, the control apparatus 10 may include a beam control unit (not illustrated) that controls a radiation direction of a beam radiated from the non-terrestrial network apparatus 20 according to a usage communication path. For example, when the direct path described above is selected as a usage communication path, the beam control unit (not illustrated) forms a phase control signal that controls a phase of a signal radiated from each antenna element of an array antenna of the non-terrestrial network apparatus 20 in such a way that a radiation direction of a beam radiated from the array antenna is directed to a direction of an area where the terminal apparatus 40 is present. Further, when the first indirect path described above is selected as a usage communication path, the beam control unit (not illustrated) forms a phase control signal that controls a phase of a signal radiated from each antenna element of an array antenna of the non-terrestrial network apparatus 20 in such a way that a radiation direction of a beam radiated from the array antenna is directed to a direction of the RIS 31.

The control apparatus 10 passes the phase control signal to the non-terrestrial network apparatus 20, and thus the non-terrestrial network apparatus 20 adjusts a phase of a signal output from each element.

Further, the terminal apparatus 40 may control directivity of a received beam according to a usage communication path. In other words, for example, when the direct path described above is selected as a usage communication path, the terminal apparatus 40 controls a phase of a signal received by each antenna element of an array antenna of the terminal apparatus 40 in such a way that a direction of a received beam is directed to a direction of the non-terrestrial network apparatus 20. Further, when the first indirect path described above is selected as a usage communication path, the terminal apparatus 40 controls a phase of a signal received by each antenna element of an array antenna of the terminal apparatus 40 in such a way that a direction of a received beam is directed to a direction of the RIS 31.

As described above, according to the first example embodiment, the acquisition unit 11 in the control apparatus 10 acquires information about interference received, from a signal transmitted from the non-terrestrial network apparatus 50, by a signal directly transmitted from the non-terrestrial network apparatus 20 to the terminal apparatus 40. The path control unit 12 selects a “usage communication path” from the direct path described above and the first indirect path described above, based on the information about the interference.

With the configuration of the control apparatus 10, a decrease in communication quality between the non-terrestrial network and the terminal apparatus can be suppressed.

### Second Example Embodiment

A second example embodiment relates to an example embodiment that selects a usage communication path from among candidates for a plurality of indirect paths.

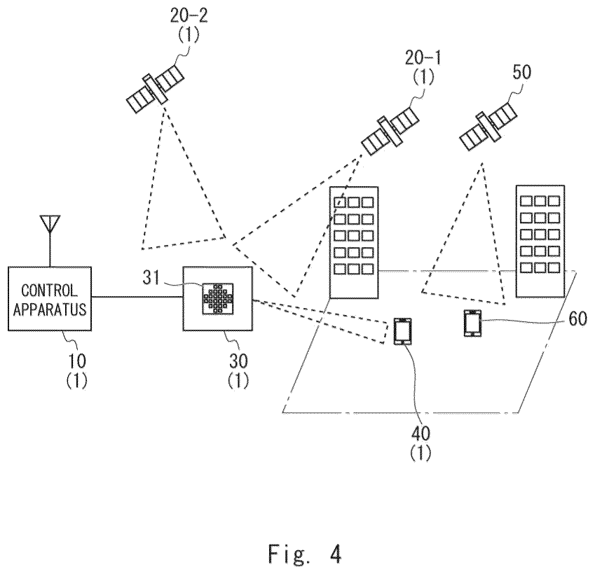

FIG. 4 is a diagram illustrating one example of a communication system according to the second example embodiment. In FIG. 4, a communication system 1 includes a control apparatus 10, non-terrestrial network apparatuses 20-1 and 20-2, a terrestrial relay apparatus 30 including an RIS 31, and a terminal apparatus 40. The non-terrestrial network apparatuses 20-1 and 20-2 are included in the first non-terrestrial network described above.

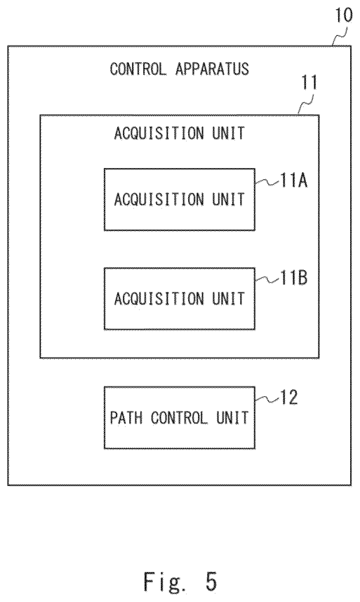

FIG. 5 is a block diagram illustrating one example of the control apparatus according to the second example embodiment. In FIG. 5, the control apparatus 10 includes an acquisition unit 11 and a path control unit 12. The acquisition unit 11 includes an acquisition unit 11A and an acquisition unit 11B.

Similarly to the acquisition unit 11 described in the first example embodiment, the acquisition unit 11A acquires information about interference received, from a signal transmitted from a non-terrestrial network apparatus 50, by a signal directly transmitted from the non-terrestrial network apparatus 20 to the terminal apparatus 40.

The acquisition unit 11B acquires information (hereinafter may be referred to as “first information”) about a reception gain in the terminal apparatus 40 of a signal passing through the first indirect path described above. For example, the terminal apparatus 40 may calculate a reception gain, based on a reference signal transmitted from the non-terrestrial network apparatus 20-1 and received via the RIS 31, and transmit the reception gain as the “first information” to the control apparatus 10.

Further, the acquisition unit 11B acquires information (hereinafter may be referred to as “second information”) about a reception gain in the terminal apparatus 40 of a signal passing through a “second indirect path”. The “second indirect path” is an indirect path in which a signal transmitted from the non-terrestrial network apparatus 20-2 indirectly reaches the terminal apparatus 40 via the RIS 31 of the terrestrial relay apparatus 30. For example, the terminal apparatus 40 may calculate a reception gain, based on a reference signal transmitted from the non-terrestrial network apparatus 20-2 and received via the RIS 31, and transmit the reception gain as the “second information” to the control apparatus 10.

The path control unit 12 in the second example embodiment selects a usage communication path from the first indirect path and the second indirect path, based on the first information and the second information described above. The selection may be performed when a usage communication path is selected from a direct path and an indirect path as described in the first example embodiment and a plurality of indirect path candidates are included in the indirect path.

For example, the path control unit 12 may select, as a usage communication path, an indirect path associated with either the above-described first or second information indicating a better reception gain. In other words, a conceivable case is where transmitting a signal from the non-terrestrial network apparatus 20-2 is advantageous in terms of a reception gain, depending on a positional relationship (such as a clearance, and an incidence angle of a radio wave) between the non-terrestrial network apparatus 20-1 and the RIS 31. In this case, selecting the second indirect path as a usage communication path is more advantageous than selecting the first indirect path.

As described above, according to the second example embodiment, the acquisition unit 11 in the control apparatus 10 acquires the first information about a reception gain in the terminal apparatus 40 of a signal passing through the first indirect path described above. The acquisition unit 11 acquires the second information about a reception gain in the terminal apparatus 40 of a signal passing through the second indirect path described above. The path control unit 12 selects a usage communication path from the first indirect path and the second indirect path, based on the first information and the second information described above.

With the configuration of the control apparatus 10, an indirect path having better reception quality can be selected.

Note that, when the non-terrestrial network apparatus 20 is an artificial satellite, a trajectory of the non-terrestrial network apparatus 20 is determined. Thus, by, first, storing a correspondence by associating a position on a trajectory of the non-terrestrial network apparatus 20-1 with a selection record of a usage communication path, the path control unit 12 can select the usage communication path by using the correspondence and information about the position on the trajectory of the non-terrestrial network apparatus 20-1.

### Third Example Embodiment

A third example embodiment relates to an example embodiment that selects a usage communication path from among candidates for a plurality of indirect paths.

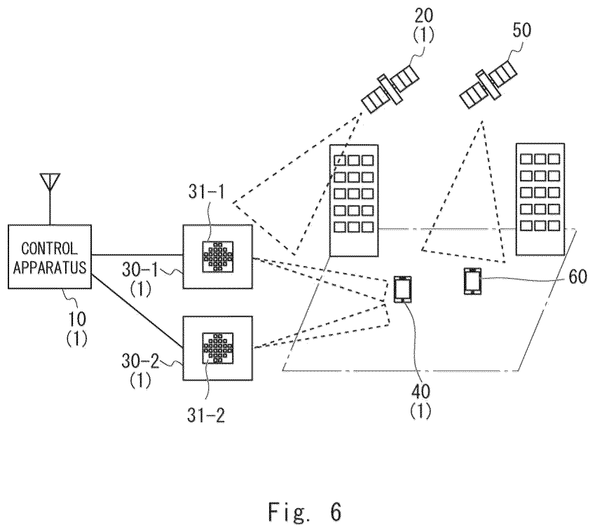

FIG. 6 is a diagram illustrating one example of a communication system according to the third example embodiment. In FIG. 6, a communication system 1 includes a control apparatus 10, a non-terrestrial network apparatus 20, a terrestrial relay apparatus 30-1 including an RIS 31-1, a terrestrial relay apparatus 30-2 including an RIS 31-2, and a terminal apparatus 40.

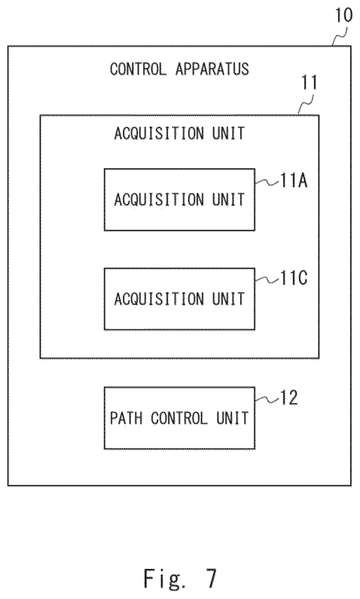

FIG. 7 is a block diagram illustrating one example of the control apparatus according to the third example embodiment. In FIG. 7, the control apparatus 10 includes an acquisition unit 11 and a path control unit 12. The acquisition unit 11 includes an acquisition unit 11A and an acquisition unit 11C.

Similarly to the acquisition unit 11 described in the first example embodiment, the acquisition unit 11A acquires information about interference received, from a signal transmitted from a non-terrestrial network apparatus 50, by a signal directly transmitted from the non-terrestrial network apparatus 20 to the terminal apparatus 40.

The acquisition unit 11C acquires first information about a reception gain in the terminal apparatus 40 of a signal passing through the first indirect path described above. For example, the terminal apparatus 40 may calculate a reception gain, based on a reference signal transmitted from the non-terrestrial network apparatus 20 and received via the RIS 31-1, and transmit the reception gain as the “first information” to the control apparatus 10.

Further, the acquisition unit 11C acquires information (hereinafter may be referred to as “third information”) about a reception gain in the terminal apparatus 40 of a signal passing through a “third indirect path”. The “third indirect path” is an indirect path in which a signal transmitted from the non-terrestrial network apparatus 20 indirectly reaches the terminal apparatus 40 via the RIS 31-2 of the terrestrial relay apparatus 30-2. For example, the terminal apparatus 40 may calculate a reception gain, based on a reference signal transmitted from the non-terrestrial network apparatus 20 and received via the RIS 31-2, and transmit the reception gain as the “third information” to the control apparatus 10.

The path control unit 12 in the third example embodiment selects a usage communication path from the first indirect path and the third indirect path, based on the first information and the third information described above. The selection may be performed when a usage communication path is selected from a direct path and an indirect path as described in the first example embodiment and a plurality of indirect path candidates are included in the indirect path.

For example, the path control unit 12 may select, as a usage communication path, an indirect path associated with either the above-described first or third information indicating a better reception gain.

As described above, according to the third example embodiment, the acquisition unit 11 in the control apparatus 10 acquires the first information about a reception gain in the terminal apparatus 40 of a signal passing through the first indirect path described above. The acquisition unit 11 acquires the third information about a reception gain in the terminal apparatus 40 of a signal passing through the third indirect path described above. The path control unit 12 selects a usage communication path from the first indirect path and the third indirect path, based on the first information and the third information described above.

With the configuration of the control apparatus 10, an indirect path having better reception quality can be selected.

### Fourth Example Embodiment

A fourth example embodiment relates to an example embodiment that selects a usage communication path from among candidates for a plurality of indirect paths.

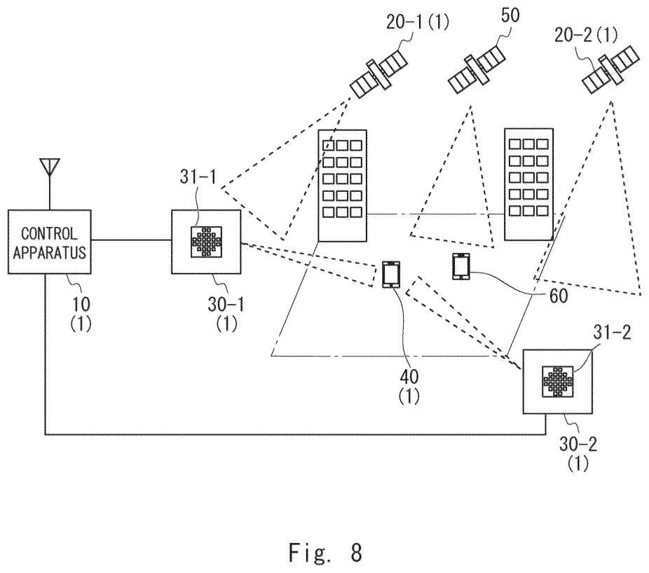

FIG. 8 is a diagram illustrating one example of a communication system according to the fourth example embodiment. In FIG. 8, a communication system 1 includes a control apparatus 10, non-terrestrial network apparatuses 20-1 and 20-2, a terrestrial relay apparatus 30-1 including an RIS 31-1, a terrestrial relay apparatus 30-2 including an RIS 31-2, and a terminal apparatus 40. The non-terrestrial network apparatuses 20-1 and 20-2 are included in the first non-terrestrial network described above.

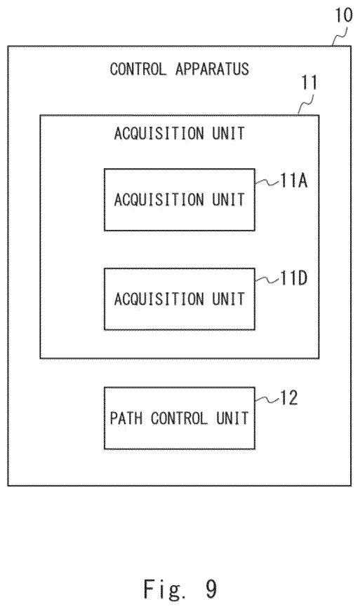

FIG. 9 is a block diagram illustrating one example of the control apparatus according to the fourth example embodiment. In FIG. 9, the control apparatus 10 includes an acquisition unit 11 and a path control unit 12. The acquisition unit 11 includes an acquisition unit 11A and an acquisition unit 11D.

Similarly to the acquisition unit 11 described in the first example embodiment, the acquisition unit 11A acquires information about interference received, from a signal transmitted from a non-terrestrial network apparatus 50, by a signal directly transmitted from the non-terrestrial network apparatus 20 to the terminal apparatus 40.

The acquisition unit 11D acquires first information about a reception gain in the terminal apparatus 40 of a signal passing through the first indirect path described above. For example, the terminal apparatus 40 may calculate a reception gain, based on a reference signal transmitted from the non-terrestrial network apparatus 20-1 and received via the RIS 31-1, and transmit the reception gain as the “first information” to the control apparatus 10.

Further, the acquisition unit 11D acquires information (hereinafter may be referred to as “fourth information”) about a reception gain in the terminal apparatus 40 of a signal passing through a “fourth indirect path”. The “fourth indirect path” is an indirect path in which a signal transmitted from the non-terrestrial network apparatus 20-2 indirectly reaches the terminal apparatus 40 via the RIS 31-2 of the terrestrial relay apparatus 30-2. For example, the terminal apparatus 40 may calculate a reception gain, based on a reference signal transmitted from the non-terrestrial network apparatus 20-2 and received via the RIS 31-2, and transmit the reception gain as the “fourth information” to the control apparatus 10.

The path control unit 12 in the fourth example embodiment selects a usage communication path from the first indirect path and the fourth indirect path, based on the first information and the fourth information described above. The selection may be performed when a usage communication path is selected from a direct path and an indirect path as described in the first example embodiment and a plurality of indirect path candidates are included in the indirect path.

For example, the path control unit 12 may select, as a usage communication path, an indirect path associated with either the above-described first or fourth information indicating a better reception gain.

As described above, according to the fourth example embodiment, the acquisition unit 11 in the control apparatus 10 acquires the first information about a reception gain in the terminal apparatus 40 of a signal passing through the first indirect path described above. The acquisition unit 11 acquires the fourth information about a reception gain in the terminal apparatus 40 of a signal passing through the fourth indirect path described above. The path control unit 12 selects a usage communication path from the first indirect path and the fourth indirect path, based on the first information and the fourth information described above.

With the configuration of the control apparatus 10, an indirect path having better reception quality can be selected.

### Modification Example

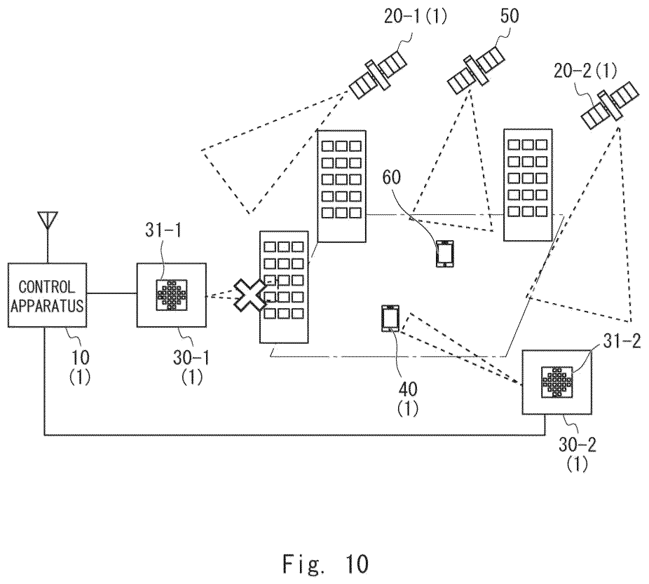

The path control unit 12 in the fourth example embodiment may select a usage communication path, based on a position of the terminal apparatus 40, a position of the RIS 31, and a position on a trajectory of the non-terrestrial network apparatus 20. In other words, for example, when the non-terrestrial network apparatus 20 is an artificial satellite, a trajectory of the non-terrestrial network apparatus 20 is determined. Thus, when a position of the non-terrestrial network apparatus 20 and a target position (target area) are determined, the RIS 31 suitable for a combination of the non-terrestrial network apparatus 20 and the target position (target area) is determined. The suitable RIS is, for example, an RIS that can see through to a target position (target area). For example, as illustrated in FIG. 10, the RIS 31-1 cannot see through to a position of the terminal apparatus 40, whereas the RIS 31-2 can see through to the position of the terminal apparatus 40. In such a situation, the path control unit 12 may select the “fourth indirect path” as a usage communication path. FIG. 10 is a diagram used for description of another selection method of a usage communication path according to the fourth example embodiment. This method is also applicable to the second example embodiment and the third example embodiment.

### Fifth Example Embodiment

A fifth example embodiment relates to an example embodiment that selects, as a usage communication path, a direct path or any one of a terrestrial path for transmission to a terminal apparatus via a land network and an indirect path.

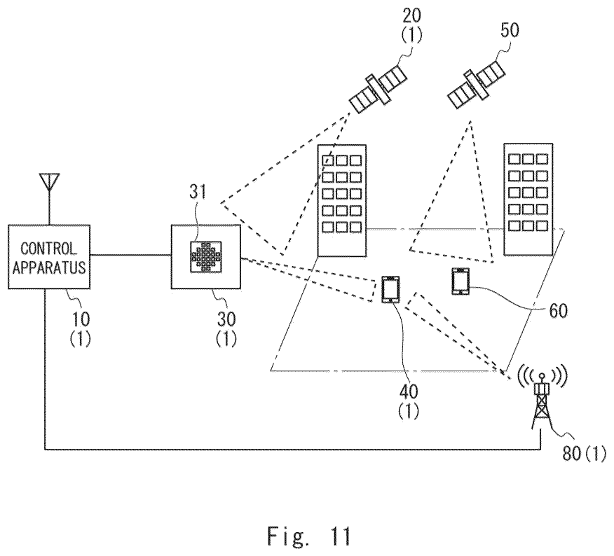

FIG. 11 is a diagram illustrating one example of a communication system according to the fifth example embodiment. In FIG. 11, a communication system 1 includes a control apparatus 10, a non-terrestrial network apparatus 20, a terrestrial relay apparatus 30 including an RIS 31, a terminal apparatus 40, and a terrestrial base station 80 of a terrestrial network.

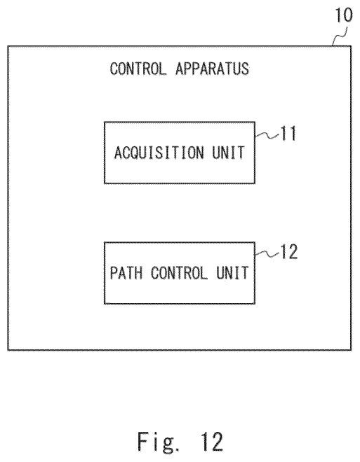

FIG. 12 is a block diagram illustrating one example of the control apparatus according to the fifth example embodiment. In FIG. 12, the control apparatus 10 includes an acquisition unit 11 and a path control unit 12.

The acquisition unit 11 in the control apparatus 10 according to the fifth example embodiment acquires information about interference received, from a signal transmitted from a non-terrestrial network apparatus 50, by a signal directly transmitted from the non-terrestrial network apparatus 20 to the terminal apparatus 40.

The path control unit 12 in the control apparatus 10 according to the fifth example embodiment selects, as a usage communication path, the direct path described above or any one of a “terrestrial path” for transmission to the terminal apparatus 40 via a land network and the first indirect path described above, based on information about interference. In FIG. 11, the “terrestrial path” is a path via the terrestrial base station 80.

For example, when it is determined that “interference” occurs, based on the information about the interference described above, the path control unit 12 may select any one of the “terrestrial path” and the first indirect path described above as the usage communication path. On the other hand, when it is determined that “interference” does not occur, based on the information about the interference described above, the path control unit 12 may select the direct path described above as the usage communication path.

Furthermore, the path control unit 12 may select a usage communication path from the “terrestrial path” and the first indirect path described above, based on a characteristic (for example, a data amount or a kind of data) of data included in a signal transmitted to the terminal apparatus 40. For example, the path control unit 12 may select the terrestrial path as a usage communication path when a data amount transmitted to the terminal apparatus 40 is equal to or more than a predetermined level, and may select the first indirect path described above as a usage communication path when a data amount transmitted to the terminal apparatus 40 is smaller than the predetermined level. Alternatively, for example, the path control unit 12 may select the first indirect path described above as a usage communication path when a kind of data is a kind that requires a low delay, and may select the terrestrial path as a usage communication path when a kind of data is a kind that permits a delay. Note that information about a characteristic of data may be acquired by the acquisition unit 11.

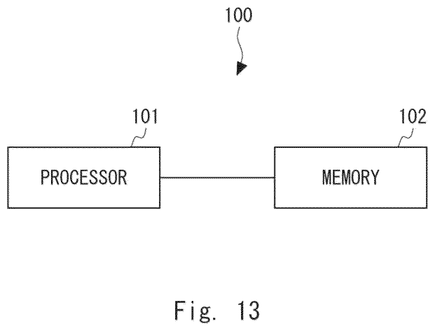

### Other Example Embodiment

<1> When a usage communication path is selected from among a plurality of indirect paths, an indirect path associated with a better reception gain may be selected as a usage communication path from any combination of the first indirect path to the fourth indirect path described in the first example embodiment to the fifth example embodiment.
<2> FIG. 13 is a diagram illustrating a hardware configuration example of a control apparatus. In FIG. 13, a control apparatus 100 includes a processor 101 and a memory 102. The processor 101 may be, for example, a microprocessor, a micro processing unit (MPU), or a central processing unit (CPU). The processor 101 may also include a plurality of processors. The memory 102 is formed of a combination of a volatile memory and a non-volatile memory. The memory 102 may include a storage disposed away from the processor 101. In this case, the processor 101 may access the memory 102 via an I/O interface that is not illustrated.

The control apparatus 10 according to the first example embodiment to the fifth example embodiment can each include the hardware configuration illustrated in FIG. 13. The acquisition unit 11 and the path control unit 12 of the control apparatus 10 according to the first example embodiment to the fifth example embodiment may be achieved by reading and executing a program stored in the memory 102 by the processor 101. The program may be stored by using various types of non-transitory computer-readable media, and may be supplied to the control apparatus 10. Examples of the non-transitory computer-readable medium include a magnetic recording medium (for example, a flexible disk, a magnetic tape, a hard disk drive), and a magneto-optical recording medium (for example, a magneto-optical disk). Moreover, examples of the non-transitory computer-readable medium include a CD-ROM (read only memory), a CD-R, and a CD-R/W. Moreover, examples of the non-transitory computer-readable medium include a semiconductor memory. The semiconductor memory includes, for example, a mask ROM, a programmable ROM (PROM), an erasable PROM (EPROM), a flash ROM, a random access memory (RAM). Further, the program may be supplied to the control apparatus 10 by various types of transitory computer-readable media. Examples of the transitory computer-readable medium include an electrical signal, an optical signal, and an electromagnetic wave. The transitory computer-readable medium may supply the program to the control apparatus 10 via a wired communication path such as an electric wire and an optical fiber or a wireless communication path.

Although the invention of the present application has been described with reference to the example embodiments, the invention of the present application is not limited to the above-described example embodiments. Various modifications that can be understood by those skilled in the art can be made to the configuration and the details of the invention of the present application within the scope of the invention.

A part or the whole of the example embodiments described above can be described as, but not limited to, the following supplementary notes.

### Supplementary Note 1

A control apparatus configured to control a usage communication path used for transmitting a signal to a terminal apparatus in a communication system including a non-terrestrial network apparatus included in a first non-terrestrial network, and a terrestrial relay apparatus including a reconfigurable intelligent surface (RIS), the control apparatus including:
a first acquisition means for acquiring information about interference received, from a signal transmitted from a second non-terrestrial network, by a signal directly transmitted from the non-terrestrial network apparatus to the terminal apparatus; and
a path control means for selecting the usage communication path from a direct path for direct transmission from the non-terrestrial network apparatus to the terminal apparatus, and an indirect path in which a signal transmitted from the non-terrestrial network apparatus indirectly arrives at the terminal apparatus via the terrestrial relay apparatus, based on the information about the interference.

### Supplementary Note 2

The control apparatus according to supplementary note 1, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus,
the control apparatus includes a second acquisition means for acquiring first information about a reception gain in the terminal apparatus of a signal passing through the first indirect path, and second information about a reception gain in the terminal apparatus of a signal passing through the second indirect path, and
the path control means selects the usage communication path from the first indirect path and the second indirect path, based on the first information and the second information.

### Supplementary Note 3

The control apparatus according to supplementary note 1, wherein
the communication system includes a second terrestrial relay apparatus,
the indirect path includes a first indirect path in which a signal transmitted from the non-terrestrial network apparatus indirectly reaches the terminal apparatus via the terrestrial relay apparatus, and a third indirect path for indirect transmission from the non-terrestrial network apparatus to the terminal apparatus via the second terrestrial relay apparatus,
the control apparatus includes a third acquisition means for acquiring first information about a reception gain in the terminal apparatus of a signal passing through the first indirect path, and third information about a reception gain in the terminal apparatus of a signal passing through the third indirect path, and
the path control means selects the usage communication path from the first indirect path and the third indirect path, based on the first information and the third information.

### Supplementary Note 4

The control apparatus according to supplementary note 1, wherein
the first non-terrestrial network includes a first non-terrestrial network apparatus, a second non-terrestrial network apparatus, and a second terrestrial relay apparatus,
the indirect path includes a first indirect path in which a signal transmitted from the first non-terrestrial network apparatus indirectly reaches the terminal apparatus via the terrestrial relay apparatus, and a fourth indirect path for indirect transmission from the second non-terrestrial network apparatus to the terminal apparatus via the second terrestrial relay apparatus,
the control apparatus includes a fourth acquisition means for acquiring first information about a reception gain in the terminal apparatus of a signal passing through the first indirect path, and fourth information about a reception gain in the terminal apparatus of a signal passing through the fourth indirect path, and
the path control means selects the usage communication path from the first indirect path and the fourth indirect path, based on the first information and the fourth information.

### Supplementary Note 5

The control apparatus according to supplementary note 1, wherein
the communication system includes a land network, and
the path control means selects, as the usage communication path, the direct path or any one of a terrestrial path for transmission to the terminal apparatus via the land network and the indirect path.

### Supplementary Note 6

The control apparatus according to supplementary note 5, wherein the path control means selects the usage communication path from the terrestrial path and the indirect path, based on a characteristic of data included in the signal.

### Supplementary Note 7

The control apparatus according to supplementary note 1, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus, and
the path control means selects the usage communication path from the first indirect path and the second indirect path, based on a position of the first non-terrestrial network apparatus, a position of the second non-terrestrial network apparatus, and a position of the terminal apparatus.

### Supplementary Note 8

The control apparatus according to supplementary note 1, wherein
the communication system includes a second terrestrial relay apparatus,
the indirect path includes a first indirect path in which a signal transmitted from the non-terrestrial network apparatus indirectly reaches the terminal apparatus via the terrestrial relay apparatus, and a third indirect path for indirect transmission from the non-terrestrial network apparatus to the terminal apparatus via the second terrestrial relay apparatus, and
the path control means selects the usage communication path from the first indirect path and the third indirect path, based on a position of the non-terrestrial network apparatus and a position of the terminal apparatus.

### Supplementary Note 9

The control apparatus according to supplementary note 1, wherein
the first non-terrestrial network includes a first non-terrestrial network apparatus, a second non-terrestrial network apparatus, and a second terrestrial relay apparatus,
the indirect path includes a first indirect path in which a signal transmitted from the first non-terrestrial network apparatus indirectly reaches the terminal apparatus via the terrestrial relay apparatus, and a fourth indirect path for indirect transmission from the second non-terrestrial network apparatus to the terminal apparatus via the second terrestrial relay apparatus, and
the path control means selects the usage communication path from the first indirect path and the fourth indirect path, based on a position of the first non-terrestrial network apparatus, a position of the second non-terrestrial network apparatus, and a position of the terminal apparatus.

### Supplementary Note 10

A control method executed by a control apparatus in a communication system, wherein
the communication system includes a non-terrestrial network apparatus included in a first non-terrestrial network, and a terrestrial relay apparatus including a reconfigurable intelligent surface (RIS),
the control method includes:
   acquiring information about interference received, from a signal transmitted from a second non-terrestrial network, by a signal directly transmitted from the non-terrestrial network apparatus to a terminal apparatus; and
   selecting a usage communication path used for transmitting a signal to a terminal apparatus in the communication system, from a direct path for direct transmission from the non-terrestrial network apparatus to the terminal apparatus, and an indirect path for indirect transmission from the non-terrestrial network apparatus to the terminal apparatus via the terrestrial relay apparatus, based on the information about the interference.

### Supplementary Note 11

The control method according to supplementary note 10, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus,
the control method includes acquiring first information about a reception gain in the terminal apparatus of a signal passing through the first indirect path, and second information about a reception gain in the terminal apparatus of a signal passing through the second indirect path, and
switching the usage communication path includes selecting the usage communication path from the first indirect path and the second indirect path, based on the first information and the second information.

### Supplementary Note 12

A non-transitory computer-readable medium storing a program causing a control apparatus in a communication system to execute processing, wherein
the communication system includes a non-terrestrial network apparatus included in a first non-terrestrial network, and a terrestrial relay apparatus including a reconfigurable intelligent surface (RIS),
the processing includes
   acquiring information about interference received, from a signal transmitted from a second non-terrestrial network, by a signal directly transmitted from the non-terrestrial network apparatus to a terminal apparatus, and
   selecting a usage communication path used for transmitting a signal to a terminal apparatus in the communication system, from a direct path for direct transmission from the non-terrestrial network apparatus to the terminal apparatus, and an indirect path for indirect transmission from the non-terrestrial network apparatus to the terminal apparatus via the terrestrial relay apparatus, based on the information about the interference.

### REFERENCE SIGNS LIST

1 COMMUNICATION SYSTEM
10 CONTROL APPARATUS
11 ACQUISITION UNIT
12 PATH CONTROL UNIT
20 NON-TERRESTRIAL NETWORK APPARATUS
30 TERRESTRIAL RELAY APPARATUS
40 TERMINAL APPARATUS
50 NON-TERRESTRIAL NETWORK APPARATUS
60 TERMINAL APPARATUS
70 RADIO WAVE MONITORING ANTENNA
80 TERRESTRIAL BASE STATION

What is claimed is:

1. A control apparatus configured to control a usage communication path used for transmitting a signal to a terminal apparatus in a communication system including a non-terrestrial network apparatus included in a first non-terrestrial network, and a terrestrial relay apparatus including a reconfigurable intelligent surface (RIS), the control apparatus comprising:
at least one memory storing instructions, and
at least one processor configured to execute, according to the instructions, processing including;
acquiring information about interference received, from a signal transmitted from a second non-terrestrial network, by a signal directly transmitted from the non-terrestrial network apparatus to the terminal apparatus; and
selecting the usage communication path from a direct path for direct transmission from the non-terrestrial network apparatus to the terminal apparatus, and an indirect path in which a signal transmitted from the non-terrestrial network apparatus indirectly reaches the terminal apparatus via the terrestrial relay apparatus, based on the information about the interference.

2. The control apparatus according to claim 1, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus,
the processing includes acquiring first information about a reception gain in the terminal apparatus of a signal passing through the first indirect path, and second information about a reception gain in the terminal apparatus of a signal passing through the second indirect path, and
the selecting includes selecting the usage communication path from the first indirect path and the second indirect path, based on the first information and the second information.

3. The control apparatus according to claim 1, wherein
the communication system includes a second terrestrial relay apparatus,
the indirect path includes a first indirect path in which a signal transmitted from the non-terrestrial network apparatus indirectly reaches the terminal apparatus via the terrestrial relay apparatus, and a third indirect path for indirect transmission from the non-terrestrial network apparatus to the terminal apparatus via the second terrestrial relay apparatus,
the processing includes acquiring first information about a reception gain in the terminal apparatus of a signal passing through the first indirect path, and third information about a reception gain in the terminal apparatus of a signal passing through the third indirect path, and
the selecting includes selecting the usage communication path from the first indirect path and the third indirect path, based on the first information and the third information.

4. The control apparatus according to claim 1, wherein
the first non-terrestrial network includes a first non-terrestrial network apparatus, a second non-terrestrial network apparatus, and a second terrestrial relay apparatus,
the indirect path includes a first indirect path in which a signal transmitted from the first non-terrestrial network apparatus indirectly reaches the terminal apparatus via the terrestrial relay apparatus, and a fourth indirect path for indirect transmission from the second non-terrestrial network apparatus to the terminal apparatus via the second terrestrial relay apparatus,
the processing includes acquiring first information about a reception gain in the terminal apparatus of a signal passing through the first indirect path, and fourth information about a reception gain in the terminal apparatus of a signal passing through the fourth indirect path, and
the selecting includes selecting the usage communication path from the first indirect path and the fourth indirect path, based on the first information and the fourth information.

5. The control apparatus according to claim 1, wherein
the communication system includes a land network, and
the selecting includes selecting, as the usage communication path, the direct path or any one of a terrestrial path for transmission to the terminal apparatus via the land network and the indirect path.

6. The control apparatus according to claim 5, wherein the selecting includes selecting the usage communication path from the terrestrial path and the indirect path, based on a characteristic of data included in the signal.

7. The control apparatus according to claim 1, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus, and
the selecting includes selecting the usage communication path from the first indirect path and the second indirect path, based on a position of the first non-terrestrial network apparatus, a position of the second non-terrestrial network apparatus, and a position of the terminal apparatus.

8. The control apparatus according to claim 1, wherein
the communication system includes a second terrestrial relay apparatus,
the indirect path includes a first indirect path in which a signal transmitted from the non-terrestrial network apparatus indirectly reaches the terminal apparatus via the terrestrial relay apparatus, and a third indirect path for indirect transmission from the non-terrestrial network apparatus to the terminal apparatus via the second terrestrial relay apparatus, and
the selecting includes selecting the usage communication path from the first indirect path and the third indirect path, based on a position of the non-terrestrial network apparatus and a position of the terminal apparatus.

9. The control apparatus according to claim 1, wherein
the first non-terrestrial network includes a first non-terrestrial network apparatus, a second non-terrestrial network apparatus, and a second terrestrial relay apparatus,
the indirect path includes a first indirect path in which a signal transmitted from the first non-terrestrial network apparatus indirectly reaches the terminal apparatus via the terrestrial relay apparatus, and a fourth indirect path for indirect transmission from the second non-terrestrial network apparatus to the terminal apparatus via the second terrestrial relay apparatus, and
the selecting includes selecting the usage communication path from the first indirect path and the fourth indirect path, based on a position of the first non-terrestrial network apparatus, a position of the second non-terrestrial network apparatus, and a position of the terminal apparatus.

10. A control method executed by a control apparatus in a communication system, wherein
the communication system includes a non-terrestrial network apparatus included in a first non-terrestrial network, and a terrestrial relay apparatus including a reconfigurable intelligent surface (RIS),
the control method comprises:
acquiring information about interference received, from a signal transmitted from a second non-terrestrial network, by a signal directly transmitted from the non-terrestrial network apparatus to a terminal apparatus; and
selecting a usage communication path used for transmitting a signal to a terminal apparatus in the communication system, from a direct path for direct transmission from the non-terrestrial network apparatus to the terminal apparatus, and an indirect path for indirect transmission from the non-terrestrial network apparatus to the terminal apparatus via the terrestrial relay apparatus, based on the information about the interference.

11. The control method according to claim 10, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus,
the control method comprises acquiring first information about a reception gain in the terminal apparatus of a signal passing through the first indirect path, and second information about a reception gain in the terminal apparatus of a signal passing through the second indirect path, and
switching the usage communication path includes selecting the usage communication path from the first indirect path and the second indirect path, based on the first information and the second information.

12. A non-transitory computer-readable medium storing a program causing a control apparatus in a communication system to execute processing, wherein
the communication system includes a non-terrestrial network apparatus included in a first non-terrestrial network, and a terrestrial relay apparatus including a reconfigurable intelligent surface (RIS),
the processing includes
acquiring information about interference received, from a signal transmitted from a second non-terrestrial network, by a signal directly transmitted from the non-terrestrial network apparatus to a terminal apparatus, and
selecting a usage communication path used for transmitting a signal to a terminal apparatus in the communication system, from a direct path for direct transmission from the non-terrestrial network apparatus to the terminal apparatus, and an indirect path for indirect transmission from the non-terrestrial network apparatus to the terminal apparatus via the terrestrial relay apparatus, based on the information about the interference.

13. The control method according to claim 10, wherein
the communication system includes a second terrestrial relay apparatus,
the indirect path includes a first indirect path in which a signal transmitted from the non-terrestrial network apparatus indirectly reaches the terminal apparatus via the terrestrial relay apparatus, and a third indirect path for indirect transmission from the non-terrestrial network apparatus to the terminal apparatus via the second terrestrial relay apparatus,
the control method comprises acquiring first information about a reception gain in the terminal apparatus of a signal passing through the first indirect path, and third information about a reception gain in the terminal apparatus of a signal passing through the third indirect path, and
the selecting includes selecting the usage communication path from the first indirect path and the third indirect path, based on the first information and the third information.

14. The control method according to claim 10, wherein
the first non-terrestrial network includes a first non-terrestrial network apparatus, a second non-terrestrial network apparatus, and a second terrestrial relay apparatus,
the indirect path includes a first indirect path in which a signal transmitted from the first non-terrestrial network apparatus indirectly reaches the terminal apparatus via the terrestrial relay apparatus, and a fourth indirect path for indirect transmission from the second non-terrestrial network apparatus to the terminal apparatus via the second terrestrial relay apparatus,
the control method comprises acquiring first information about a reception gain in the terminal apparatus of a signal passing through the first indirect path, and fourth information about a reception gain in the terminal apparatus of a signal passing through the fourth indirect path, and
the selecting includes selecting the usage communication path from the first indirect path and the fourth indirect path, based on the first information and the fourth information.

15. The control method according to claim 10, wherein
the communication system includes a land network, and
the selecting includes selecting, as the usage communication path, the direct path or any one of a terrestrial path for transmission to the terminal apparatus via the land network and the indirect path.

16. The control method according to claim 15, wherein the selecting includes selecting the usage communication path from the terrestrial path and the indirect path, based on a characteristic of data included in the signal.

17. The control method according to claim 10, wherein
the first non-terrestrial network includes a first non-terrestrial network apparatus and a second non-terrestrial network apparatus,
the indirect path includes a first indirect path in which a signal transmitted from the first non-terrestrial network apparatus indirectly reaches the terminal apparatus via the terrestrial relay apparatus, and a second indirect path for indirect transmission from the second non-terrestrial network apparatus to the terminal apparatus via the terrestrial relay apparatus, and
the selecting includes selecting the usage communication path from the first indirect path and the second indirect path, based on a position of the first non-terrestrial network apparatus, a position of the second non-terrestrial network apparatus, and a position of the terminal apparatus.

18. The control method according to claim 10, wherein
the communication system includes a second terrestrial relay apparatus,
the indirect path includes a first indirect path in which a signal transmitted from the non-terrestrial network apparatus indirectly reaches the terminal apparatus via the terrestrial relay apparatus, and a third indirect path for indirect transmission from the non-terrestrial network apparatus to the terminal apparatus via the second terrestrial relay apparatus, and
the selecting includes selecting the usage communication path from the first indirect path and the third indirect path, based on a position of the non-terrestrial network apparatus and a position of the terminal apparatus.

19. The control method according to claim 10, wherein
the first non-terrestrial network includes a first non-terrestrial network apparatus, a second non-terrestrial network apparatus, and a second terrestrial relay apparatus,
the indirect path includes a first indirect path in which a signal transmitted from the first non-terrestrial network apparatus indirectly reaches the terminal apparatus via the terrestrial relay apparatus, and a fourth indirect path for indirect transmission from the second non-terrestrial network apparatus to the terminal apparatus via the second terrestrial relay apparatus, and
the selecting includes selecting the usage communication path from the first indirect path and the fourth indirect path, based on a position of the first non-terrestrial network apparatus, a position of the second non-terrestrial network apparatus, and a position of the terminal apparatus.
